(19) United States
(12) Patent Application Publication
(10) Pub. No.: US 2014/0300467 A1
(43) Pub. Date: Oct. 9, 2014

(54) System for Locating Tagged Objects

(71) Applicant: Joel Ho, Saratoga, CA (US)

(72) Inventor: Joel Ho, Saratoga, CA (US)

(21) Appl. No.: 13/857,066

(22) Filed: Apr. 4, 2013

(51) Int. Cl. G08B 3/00

(52) U.S. Cl. CPC G08B 3/00
USPC 340/539.13

(57) ABSTRACT

A system comprises a master unit being configured to be operable to at least transmit and receive signals, determine signal levels of received signals, and activate an alarm for received signal levels below a predetermined level. The master unit at least comprises a processing unit, a port for communicating with computing devices, and a speaker unit for producing an audible alarm. At least two slave units are configured to be operable to at least transmit and receive signals, determine signal levels of received signals, and activate an alarm for received signal levels below a predetermined level and for signal content indicating an alarm. Each of the slave units comprises a processing, a port for communicating with computing devices, and a speaker unit for producing an audible alarm. The master unit communicates separately with each of the slave units.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to locating objects. More particularly, one or more embodiments of the invention relate to locating objects based on a signal strength between a master and slave transreceiver.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that real-time locating systems are used to automatically identify and track the location of objects or people in real time, usually within a building or other contained area. Wireless real-time locating systems tags are attached to objects or worn by people, and in most real-time locating systems, fixed reference points receive wireless signals from tags to determine their location.

Typically, the physical layer of real-time locating systems technology is usually some form of radio frequency communication, but some systems use optical or acoustic technology instead of or in addition to radio frequencies. Tags and fixed reference points can be transmitters, receivers, or both, resulting in numerous possible technology combinations.

Typically, radio frequency is a rate of oscillation in the range of about 3 kHz to 500 GHz, which corresponds to the frequency of radio waves, and the alternating currents which carry radio signals.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a block diagram for an exemplary tracking system, in accordance with an embodiment of the present invention;

FIG. 2 illustrates a circuit diagram for an exemplary tracking system, in accordance with an embodiment of the present invention;

FIG. 3 illustrates a top view of an exemplary received signal strength indicator, in accordance with an embodiment of the present invention;

FIG. 4 illustrates an exemplary charger synchronizing an exemplary master transreceiver and an exemplary slave transreceiver, in accordance with an embodiment of the present invention;

FIG. 5 illustrates an exemplary communication flow for a tracking system, in accordance with an embodiment of the present invention;

FIG. 6 illustrates an exemplary process for communication between transreceivers, in accordance with an embodiment of the present invention;

FIGS. 7A and 7B illustrate an exemplary construction of a transreceiver, in accordance with an embodiment of the present invention. FIG. 7a is a top view the transreceiver. FIG. 7b is a side view of the transreceiver; and

FIG. 8 illustrates an exemplary computer system that, when appropriately configured or designed, can serve as an exemplary tracking system, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

The present invention will now be described in detail with reference to embodiments thereof as illustrated in the accompanying drawings.

There are various types of tracking systems that may be provided by preferred embodiments of the present invention. In one embodiment of the present invention, the tracking system may provide a plurality of transreceivers that simultaneously emit an alert signal when a distance, trajectory, or velocity of a transreceiver causes a signal level to fall below a predetermined threshold. In some embodiments, a master transreceiver may send out a signal having a constant strength to a plurality of slave transreceivers or a single transreceiver. In some embodiments, the master transreceiver may send several types of signals on different frequencies through different channels to several different slave devices on different time and each slave device is contacted sequentially. Those skilled in the art, in light of the present teachings, will recognize that the strength of the signal between the master and slave transreceivers may include a magnitude of an electrical field at the slave transreceiver in relation to the master transreceiver. In some embodiments, changes in the distance between the master and slave transreceivers may indicate a change in trajectory and velocity between the transreceivers. A received signal strength indicator (RSSI) may detect and indicate the changes in distance between the transreceivers. For example, without limitation, the constant signal received by the slave transreceivers may weaken as the distance between transreceivers increases. The received signal strength indicator may identify the change from a constant signal to a weaker or stronger signal. A processor may include the means to detect the changes in signal strength. For example, without limitation, when the tracking system detects that the constant signal between transreceivers is weaker, the master transreceiver and the slave transreceivers may start to communicate on a much more frequent basis to verify the reduced signal strength and mitigate false alarms. In this manner, if the signal continues to transmit at a weaker strength, the transreceivers may be moving apart from each other. In some embodiments, the slave transreceiver may position on the object, whereby the master transreceiver may detect a relative distance to the object by transmitting the signal to the slave transreceiver The user may locate the devices through audio tones generated by the devices. In some alternate embodiments, the transreceivers further include Global Positioning Satellite (GPS) receivers. With the use of GPS, the locations of each transceiver can be known, within the resolution of the GPS. In yet another embodiment, the master transreceiver may utilize triangulation to determine the position, velocity, and trajectory of the slave transreceivers, and thereby the object. Those skilled in the art, in light of the present teachings, will recognize that the master transreceiver may determine the location of the slave transreceivers by measuring angles from known points at either end of a baseline.

In one embodiment of the present invention, the tracking system may include an alert signal to indicate changes in the signal strength between the transreceivers. The alert signal may trigger when the constant signal strength between the master and slave transreceivers falls below a predetermined strength or threshold. The signal may include, without limitation, a radio frequency, radiation, illumination, laser, and a sound wave. In some embodiments, the signal may be encrypted to restrict duplication. In some embodiments, the alert signal may continuosly provide an audible signal until the master transreceiver and the slave transreceiver are in possession of the user. However, in other embodiments, the alert signal may terminate after a predetermined time interval. In some embodiments, a volume control portion may regulate the volume of the alert signal. However in another embodiment, the alert signal volume may be adjusted only if the master transreceiver and the slave tranreceivers are set to the same setting. In one embodiment, if one transreceiver is turned to a lower volume and the other transreceiver remains on the higher setting, then the alert signal may default to the higher audible setting. In yet another embodiment, only a user who physically possesses both transreceivers may adjust the volume control to a lower alert signal.

In one embodiment of the present invention, the transreceivers may include a master transreceiver, and a slave transreceiver. Each respective transreceiver may communicate in master/slave mode where the master transreceiver initiates a data frame with to the slave transreceiver. The contents of the data frame may include a short encrypted message used to bond the master and slave. The master transreceiver may detect the signal strength from the slave transreceivers to determine whether to generate an alert signal. In one embodiment, a user may have access to the master transreceiver, while an object to be tracked may be fitted with a slave transreceiver. In this manner, the tracking system may dynamically alert the user that the object exceeded a predetermined range. In some embodiments, the network may include a single master transreceiver and a plurality of slave transreceivers. The network may be configured to tie the master transreceivers and the slave transreceiver together for communication. In this manner, any element of the tracking system may help locate an object tagged with a slave transreceiver by first alerting the master transreceiver, and then forwarding the alert to the slave transreceiver on the object.

In one embodiment of the present invention, the tracking system may include a mobile encrypted network. The network may encrypt the signals when transmitting them between each transreceiver. In this manner, the network may be operable to inhibit interference from other networks or systems designed to hinder signals. Those skilled in the art, in light of the present teachings, will recognize that the encryption of signals may be efficacious in protecting military or commercial interests in the location of the object. Encryption of the signal may include, without limitation, encryption algorithm such as, but not limited to, an advanced encryption standard (AES) that converts the signal into an unreadable ciphertext.

In one embodiment of the present invention, the tracking system may include a charger system. The charger may have an embedded program port which automatically updates and synchronizes the master and slaves' firmware while allowing the user to adjust certain security-related parameters. During the charging process, transceivers continue to send the signals to each other. However, while connected to the charger, the user may opt for the transceivers to be reprogrammed and updated, which would lead the transceivers to use the program port exclusively to communicate with each other through the charger. In some embodiments, the charger may set a predetermined threshold distance for the signal. When the signal exceeds the threshold, the transreceivers may emit an alert signal. In some embodiments, the slave transreceiver may detect the signal strength of the master transreceiver, while the master transreceiver may detect the signal strength of the rest of the slave transreceivers. In some embodiments, if the master transreceiver is lost, the tracking system may be reset so that the charger selects a new master transreceiver from the remaining slave transreceivers. The remaining transreceivers may then be synchronized to transmit and receive signals as appropriate. In some alternate embodiments, the charger may be in communication with local or mobile computing device. The communication may be established by either a wired or wireless connection. The user of the computing device may then view and set operating parameters for the tracking system.

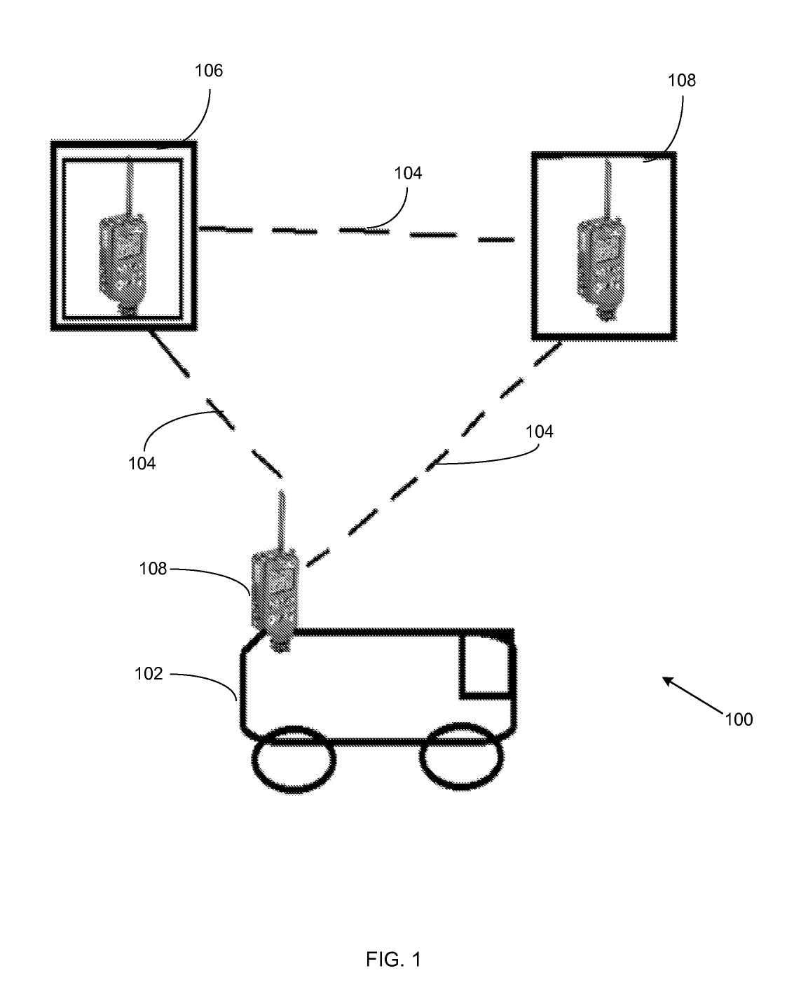

FIG. 1 illustrates a block diagram for an exemplary tracking system, in accordance with an embodiment of the present invention. In the present invention, the tracking system 100 may provide a plurality of transreceivers that simultaneously emit an alert signal when a distance, trajectory, or velocity of an object 102 exceeds a predetermined threshold. The transreceivers may include, without limitation, transponders, transverters, and repeaters. An alert signal may trigger when a signal strength 104 between the transreceivers falls below a predetermined strength. The signal strength may include, without limitation, a radio frequency, and a sound wave. A received signal strength indicator (RSSI) may detect when a constant signal changes due to a change in distance between transreceivers. In some other embodiments, microphones may be included as well to record a human voice to send messages besides the basic alert sounds. The alert signal may include, without limitation, audible sounds, illumination, and vibrations. In some embodiments, the signal may be encrypted to restrict duplication and provide security. In some embodiments, the volume of the alert signal may be adjusted only if the master transreceiver and the slave transceivers are set to the same setting. Those skilled in the art, in light of the present teachings, will recognize that this requirement may be beneficial for deterring theft of the object, whereby the alert signal in the slave transreceiver may be utilized to draw attention to the object. However in other embodiments, if the alert signal on either the master or slave transreceiver is set to a lower volume, and the other transreceiver remains on the higher setting, then the system may default to the higher audible setting for both transreceivers simultaneously.

In one embodiment of the present invention, the transreceivers may include a master transreceiver 106, and a plurality of slave transreceivers 108. In some embodiments, the transreceivers may communicate in master/slave mode where a master transreceiver initiates the data frame with a slave transreceiver. The master transreceiver may detect the signal strength from the slave transreceivers to determine whether to generate an alert signal. In one embodiment, a user may have access to the master transreceiver, while an object 102 to be tracked may be fitted with a slave transreceiver. The relative distance to the object may then be identified based on the signal strength between the master and slave transreceiver. In this manner, the tracking system may dynamically alert the user that the object exceeded a predetermined range. For example, without limitation, the master transreceiver may join with a personal key chain, while a slave transreceiver joins with a wallet. The distance to the wallet may be monitored by a user as long as the key chain remains with the user. When the wallet exceeds a predetermined threshold from the key chain, the alert signal may trigger on both the key chain and the wallet. The present embodiment enables a master transceiver to accept up to three slaves while being capable of accepting up to ten downstream slaves while acting itself as a slave to another master, allowing for effectively unlimited connections using cascading techniques. The number of slaves is limited by the power of the microprocessor. In a non-limiting example, using a 64 bit processor and without power limitations, thousands of slaves may be connected to one master.

In one alternative embodiment of the present invention, destruction or failure of any one of the transreceivers may result in triggering alert signals on the remaining transreceivers. In yet another embodiment, unauthorized movement of any of the transreceivers may trigger alert signals on the remaining transreceivers. In yet another embodiment, attempts to jam the signal between the transreceivers may trigger alert signals on the remaining transreceivers. In one alternative embodiment, the signals from the master and slave transreceiver may travel to a remote satellite and server for redirection and analysis at a remote control center. In this manner, the relative distance to the object may be monitored from the remote control center. In yet another alternative embodiment, a social site may be utilized to monitor the object, whereby the transreceivers transmit a signal to a server.

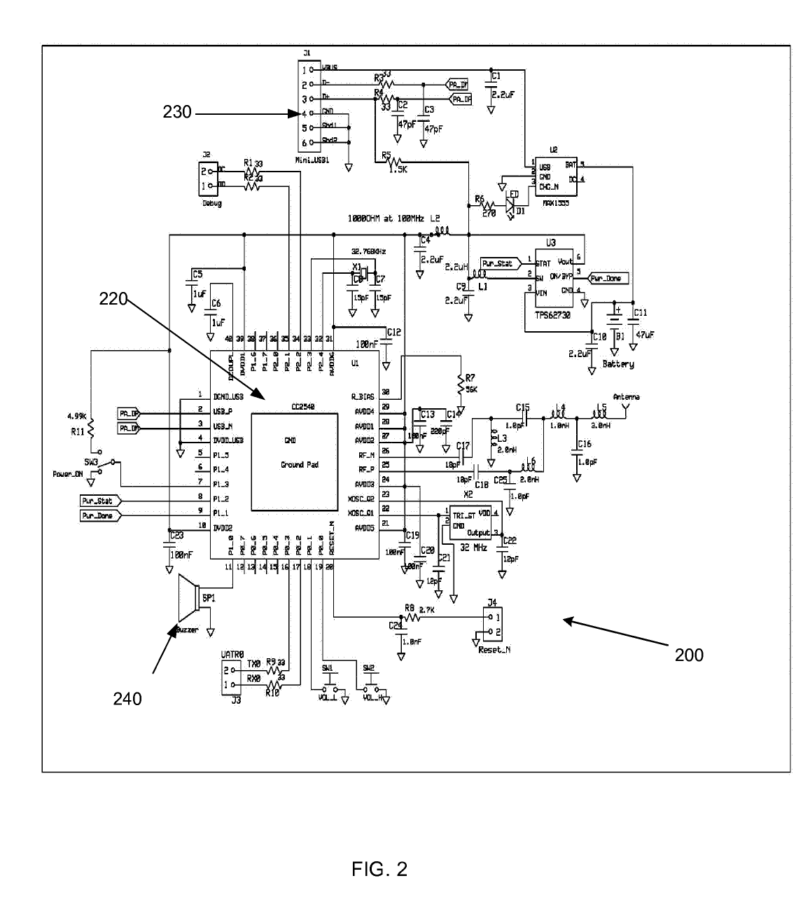

FIG. 2 illustrates a circuit diagram for an exemplary tracking system, in accordance with an embodiment of the present invention. In the present invention, the circuit 200 may include a radio frequency module configured to transmit and/or receive radio signals on a plurality of carrier frequencies. Circuit at least includes a processor unit 220, a universal serial bus (USB) port 230, and a speaker 240 for producing audible alarms. In some embodiments, the master and slave transreceivers may utilize various frequencies for communicating with each other about the distance to the object, including, without limitation 392 MHz, 415 MHz, 868 MHz and 915 MHz. However in other embodiments, other frequencies may be utilized. In some embodiments, the use of multiple frequencies is done for reasons of compliance with existing Bluetooth protocols that mandate that no single device may occupy a single frequency beyond a certain period of time, in order to avoid conflict with other devices in the environment.

In one embodiment of the present invention, the tracking system may include an alert signal to indicate changes in the signal strength between the transreceivers. The alert signal may trigger when the constant signal strength between the master and slave transreceivers falls below a predetermined strength or threshold. The signal may include, without limitation, a radio frequency, radiation, illumination, laser, and a sound wave. In some embodiments, the signal may be encrypted to restrict duplication. In some embodiments, the alert signal may continuously provide an audible signal until the master transreceiver and the slave transreceiver are in possession of the user. However, in other embodiments, the alert signal may terminate after a predetermined time interval. In some embodiments, a volume control portion may regulate the volume of the alert signal. However in another embodiment, the alert signal volume may be adjusted only if the master transreceiver and the slave tranreceivers are set to the same setting. In one embodiment, if one transreceiver is turned to a lower volume and the other transreceiver remains on the higher setting, then the alert signal may default to the higher audible setting. In yet another embodiment, only a user who physically possesses both transreceivers may adjust the volume control to a lower alert signal.

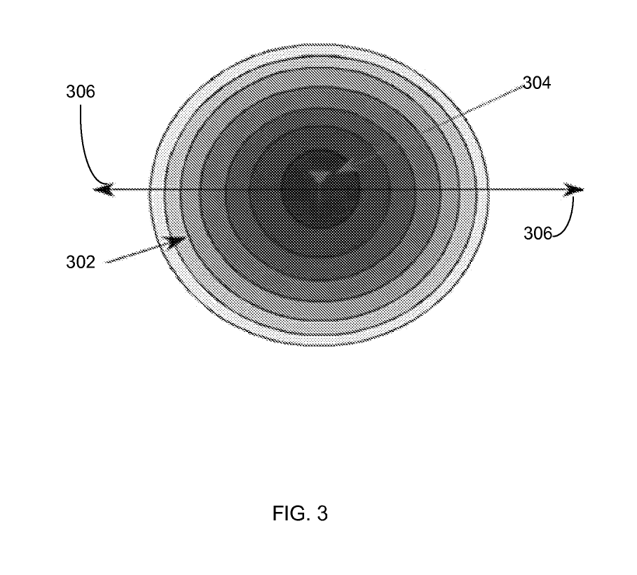

FIG. 3 illustrates a top view of an exemplary received signal strength indicator, in accordance with an embodiment of the present invention. This indicator represents a signal sent between the devices. In the present invention, a received signal strength indicator (RSSI) 302 may detect and indicate the changes in distance between master transreceiver 304 and a plurality of slave transreceivers 306 or a single slave transreceiver. For example, without limitation, the constant signal received by the slave transreceivers may weaken as the distance between transreceivers increases. The received signal strength indicator may identify the change from a constant signal to a weaker or stronger signal.

In one embodiment of the present invention, the tracking system may include a mobile encrypted network. The network may encrypt the signals when transmitting them between each transreceiver. In this manner, the network may be operable to inhibit interference from other networks or systems designed to hinder signals. Those skilled in the art, in light of the present teachings, will recognize that the encryption of signals may be efficacious in protecting military or commercial interests in the location of the object. Encryption of the signal may include, without limitation, an encryption algorithm that converts the signal into an unreadable ciphertext. In some embodiments, the mobile encrypted network may include a single master transreceiver and a plurality of slave transreceivers. The mobile encrypted network may be configured to tie the master transreceivers and the slave transreceiver together for communication. In this manner, any element of the tracking system may help locate an object tagged with a slave transreceiver by first alerting the master transreceiver, and then forwarding the alert to the slave transreceiver on the object. In one embodiment, the network may include encrypted communication between each transreceiver. In this manner, the network may be operable to inhibit interference from other networks or systems designed to hinder signals. The network may include various communication protocols for allowing the transreceivers to communicate with each other, including, without limitation, two Ethernets, hardware and link layer standard, Internet protocol suite, host-to-host data transfer, and application-specific data transmission formats.

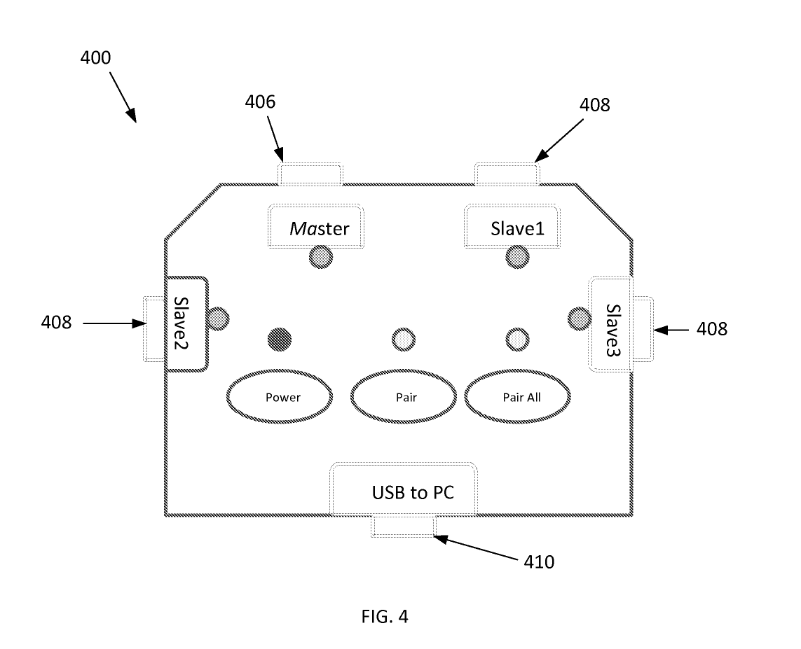

FIG. 4 illustrates an exemplary charger synchronizing an exemplary master transreceiver and an exemplary slave transreceiver, in accordance with an embodiment of the present invention. In the present invention, the tracking system may include a charger system 400. The charger may be operable charge the tranreceiver, to enable communication to a computing device, and to synchronize all the transreceivers. In some embodiments, if a master transreceiver 406 is lost, the tracking system may be reset so that the charger selects a new master transreceiver from the remaining slave transreceivers 408. In this manner, the remaining transreceivers may be synchronized or paired. In one embodiment of the present invention, the tracking system may include a processor portion, not shown, for coordinating the components of the tracking system. The processor portion may include sufficient processing power to synchronize the communication between the master transreceiver and the slave transreceivers. The charger may have an embedded program port which automatically updates and synchronizes the master and slaves' firmware while allowing the user to adjust certain security-related parameters. During the charging process, transceivers continue to send the signals to each other. However, while connected to the charger, the user may opt for the transceivers to be reprogrammed and updated, which would lead the transceivers to use the program port exclusively to communicate with each other through the charger. In some embodiments, the charger may set a predetermined threshold distance for the signal. When the signal exceeds the threshold, the transreceivers may emit an alert signal. In some embodiments, the slave transreceiver may detect the signal strength of the master transreceiver, while the master transreceiver may detect the signal strength of the rest of the slave transreceivers. In some embodiments, if the master transreceiver is lost, the tracking system may be reset so that the charger selects a new master transreceiver from the remaining slave transreceivers. The remaining transreceivers may then be synchronized to transmit and receive signals as appropriate. In some alternate embodiments, the charger may be in communication with local or mobile computing device 410. The user of the computing device may then view and set operating parameters for the tracking system. In some embodiments, the charger may set a predetermined threshold distance for the signal. When the signal exceeds the threshold, the transreceivers may emit an alert signal. In some embodiments, at determined sub-second intervals, the transceivers may broadcast their encrypted signal. The slave transreceiver may detect the signal strength of the master transreceiver, while the master transreceiver may detect the signal strength of all the devices in the network.

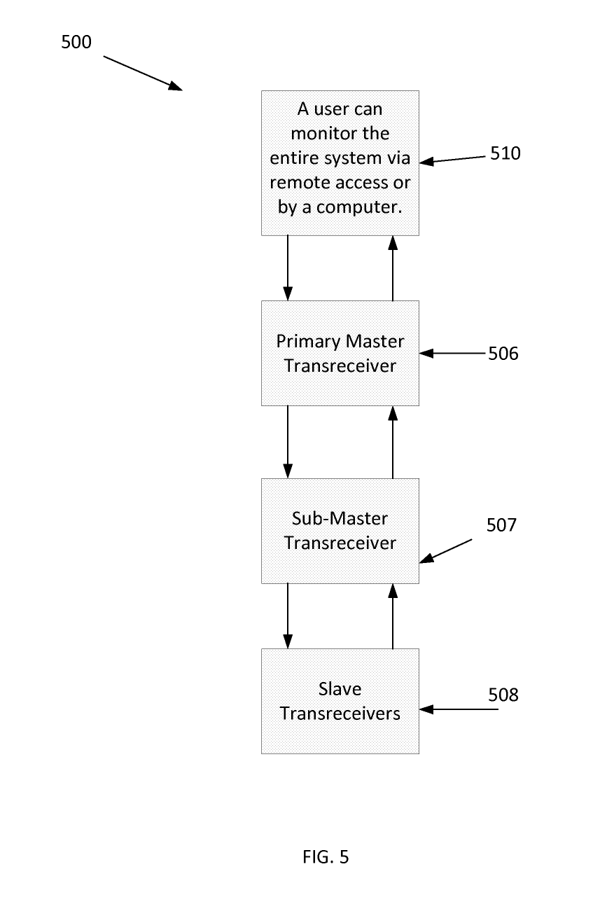

FIG. 5 illustrates an exemplary communication flow for a tracking system, in accordance with an embodiment of the present invention. In the present invention, a user can monitor the entire system 500 via a remote access or computing device 510 by communicating with primary master transreceiver 506. Primary master transreceiver 506 in turn may communicate with one or more sub-master transreceivers 507. Each sub-master transreceiver may in turn communicate with a plurality of slave transreceivers 508. In this system, status of the slave transreceivers 508 is communicated up through the system to the primary transreceiver 506 where user at 501 may monitor. In some embodiments, there are no sub-master transreceivers and primary master transreceiver 506 may communicate directly with a plurality of slave transreceivers 508.

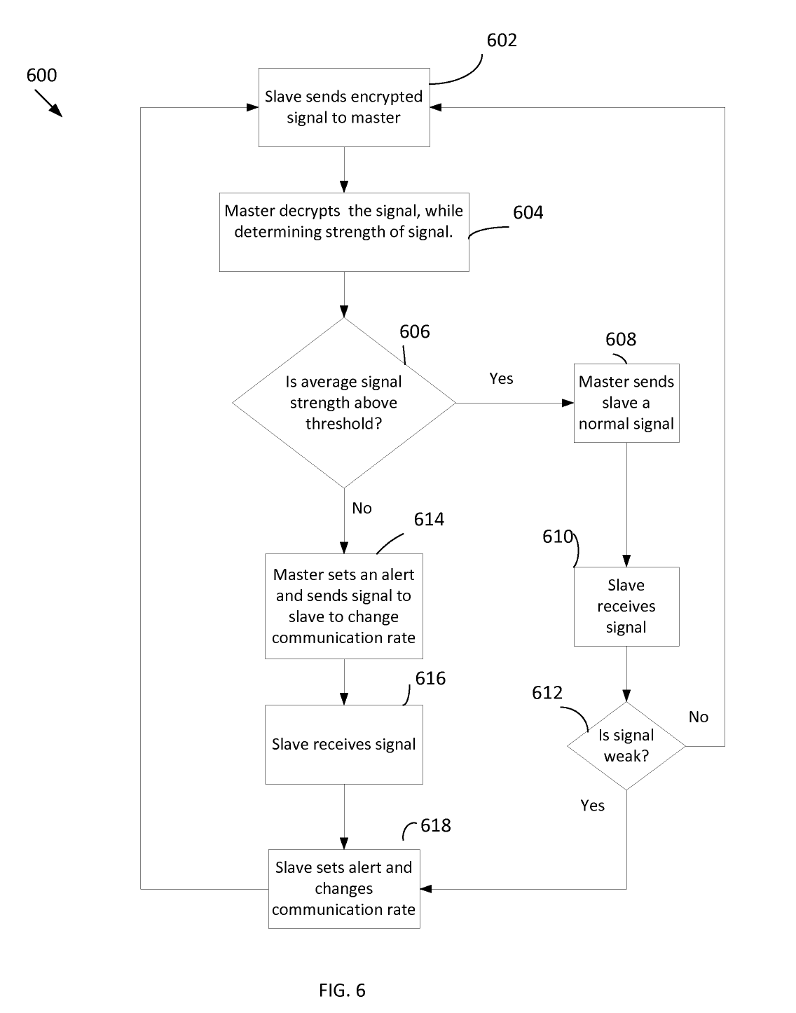

FIG. 6 illustrates an exemplary process for communication between transreceivers, in accordance with an embodiment of the present invention. A process 600 exemplifies a communication between transreceivers that may occur. In a step 602, a slave transreceiver sends and encrypted signal to a master transreceiver. In a step 604, the master transreceiver receives the signal, decrypts the signal and determines strength of the signal. In a step 606, master transreceiver computes a running average of the received signal strength and previous signal strengths from the slave transreceiver. If the running average is above a predetermined threshold, the master transreceiver sends a normal signal to the slave transreceiver in a step 608. In a step 610, the slave transreceiver receives the signal from the master transreceiver and determines a signal strength. If that signal strength is above a predetermined level in a step 612, the slave transreceiver communicates a signal to the master transreceiver in 602. If the received signal strengths remain above predetermined levels, the slave transreceiver repeatedly signals the master transreceiver at a first periodic rate. In a non-limiting example, this rate may be on the order of about 200 ms. If the signal strength in 612 is below the predetermined level, the slave transreceiver sets an alert and changes the periodic rate to a second faster rate. In a non-limiting example, this second rate may be on the order of about 100 ms. If the running average in 606 is below the predetermined threshold, the master transreceiver sets an alert for the slave transreceiver and sends a signal to the slave transreceiver to change to the second rate in a step 614. In a step 616, the slave receives the signal to change the rate. In a step 618, the slave transreceiver sets an alert and changes the rate. The slave transreceiver then continues sending the signal at the second rate in 602.

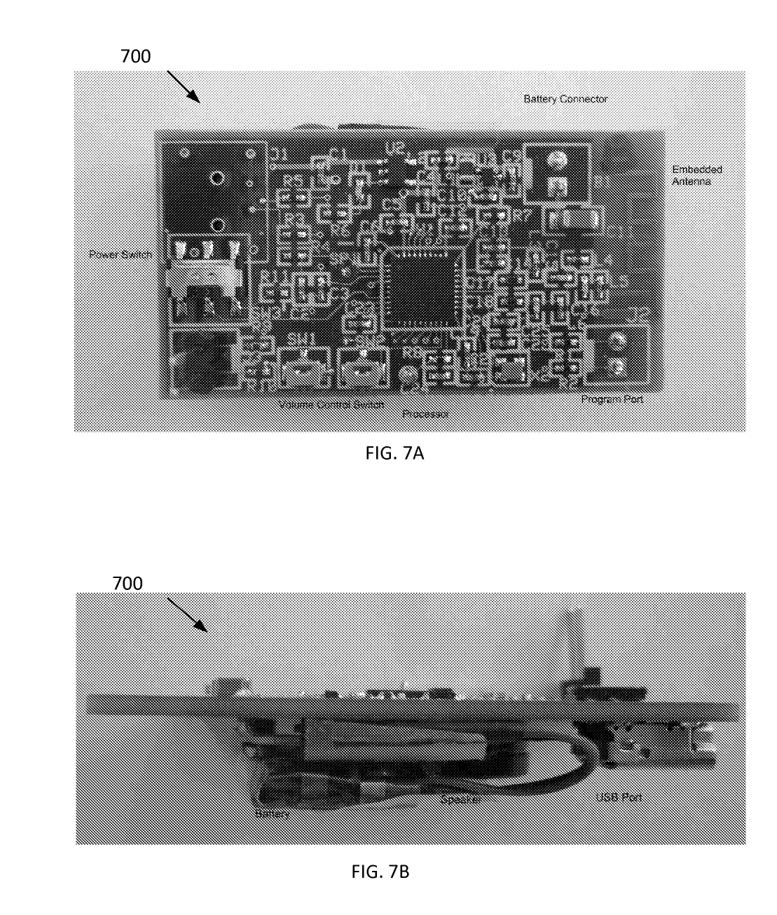

FIGS. 7A and 7B illustrate an exemplary construction of a transreceiver, in accordance with an embodiment of the present invention. FIG. 7a is a top view the transreceiver. FIG. 7b is a side view of the transreceiver.

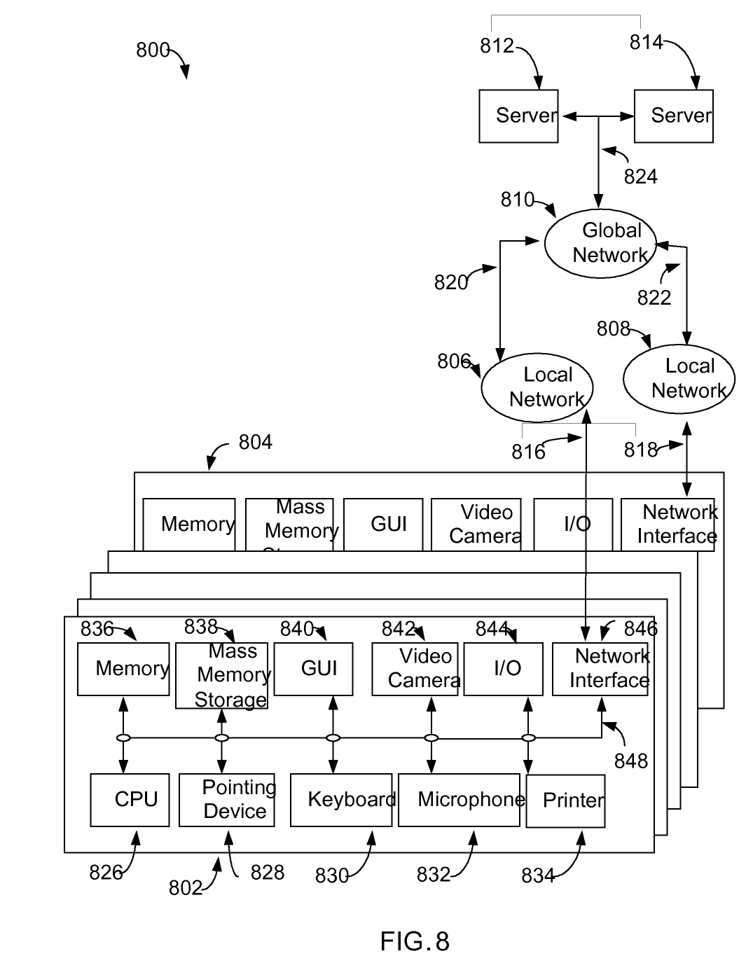

FIG. 8 illustrates an exemplary computer system that, when appropriately configured or designed, can serve as an exemplary tracking system, in accordance with an embodiment of the present invention. In the present invention, a communication system 800 includes a multiplicity of clients with a sampling of clients denoted as a client 802 and a client 804, a multiplicity of local networks with a sampling of networks denoted as a local network 806 and a local network 808, a global network 810 and a multiplicity of servers with a sampling of servers denoted as a server 812 and a server 814.

Client 802 may communicate bi-directionally with local network 806 via a communication channel 816. Client 804 may communicate bi-directionally with local network 808 via a communication channel 818. Local network 806 may communicate bi-directionally with global network 810 via a communication channel 820. Local network 808 may communicate bi-directionally with global network 810 via a communication channel 822. Global network 810 may communicate bi-directionally with server 812 and server 814 via a communication channel 824. Server 812 and server 814 may communicate bi-directionally with each other via communication channel 824. Furthermore, clients 802, 804, local networks 806, 808, global network 810 and servers 812, 814 may each communicate bi-directionally with each other.

In one embodiment, global network 810 may operate as the Internet. It will be understood by those skilled in the art that communication system 800 may take many different forms. Non-limiting examples of forms for communication system 800 include local area networks (LANs), wide area networks (WANs), wired telephone networks, wireless networks, or any other network supporting data communication between respective entities.

Clients 802 and 804 may take many different forms. Non-limiting examples of clients 802 and 804 include personal computers, personal digital assistants (PDAs), cellular phones and smartphones.

Client 802 includes a CPU 826, a pointing device 828, a keyboard 840, a microphone 842, a printer 844, a memory 846, a mass memory storage 848, a GUI 840, a video camera 842, an input/output interface 844 and a network interface 846.

CPU 826, pointing device 828, keyboard 840, microphone 842, printer 844, memory 846, mass memory storage 848, GUI 840, video camera 842, input/output interface 844 and network interface 846 may communicate in a unidirectional manner or a bi-directional manner with each other via a communication channel 848. Communication channel 848 may be configured as a single communication channel or a multiplicity of communication channels.

CPU 826 may be comprised of a single processor or multiple processors. CPU 826 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 846 is used typically to transfer data and instructions to CPU 826 in a bi-directional manner. Memory 846, as discussed previously, may include any suitable computer-readable media, intended for data storage, such as those described above excluding any wired or wireless transmissions unless specifically noted. Mass memory storage 848 may also be coupled bi-directionally to CPU 826 and provides additional data storage capacity and may include any of the computer-readable media described above. Mass memory storage 848 may be used to store programs, data and the like and is typically a secondary storage medium such as a hard disk. It will be appreciated that the information retained within mass memory storage 848, may, in appropriate cases, be incorporated in standard fashion as part of memory 846 as virtual memory.

CPU 826 may be coupled to GUI 840. GUI 840 enables a user to view the operation of computer operating system and software. CPU 826 may be coupled to pointing device 828. Non-limiting examples of pointing device 828 include computer mouse, trackball and touchpad. Pointing device 828 enables a user with the capability to maneuver a computer cursor about the viewing area of GUI 840 and select areas or features in the viewing area of GUI 840. CPU 826 may be coupled to keyboard 840. Keyboard 840 enables a user with the capability to input alphanumeric textual information to CPU 826. CPU 826 may be coupled to microphone 842. Microphone 842 enables audio produced by a user to be recorded, processed and communicated by CPU 826. CPU 826 may be connected to printer 844. Printer 844 enables a user with the capability to print information to a sheet of paper. CPU 826 may be connected to video camera 842. Video camera 842 enables video produced or captured by user to be recorded, processed and communicated by CPU 826.

CPU 826 may also be coupled to input/output interface 844 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 826 optionally may be coupled to network interface 846 which enables communication with an external device such as a database or a computer or telecommunications or internet network using an external connection shown generally as communication channel 816, which may be implemented as a hardwired or wireless communications link using suitable conventional technologies. With such a connection, CPU 826 might receive information from the network, or might output information to a network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing a locating system that utilizes a plurality of transreceivers in communication that emit alert signals according to the present invention will be apparent to those skilled in the art. Various aspects of the invention have been described above by way of illustration, and the specific embodiments disclosed are not intended to limit the invention to the particular forms disclosed. The particular implementation of the locating system that utilizes a plurality of transreceivers in communication that emit alert signals may vary depending upon the particular context or application. By way of example, and not limitation, the a locating system that utilizes a plurality of transreceivers in communication that emit alert signals described in the foregoing were principally directed to a locating system that utilizes a plurality of transreceivers in communication that emit alert signals implementations; however, similar techniques may instead be applied to military reconnaissance missions that require multiple soldiers to track each other's position, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

1. A system comprising:
a master unit being configured to be operable to at least transmit and receive signals, determine signal levels of received signals, and activate an alarm for received signal levels below a predetermined level, said master unit at least comprising: a processing unit being configured to be operable to control transmission and reception on multiple frequencies, and to process transmitted and received signals, a port for communicating with computing devices, and a speaker unit for producing an audible alarm; and
at least one slave unit being configured to be operable to at least transmit and receive signals, determine signal levels of received signals, and activate an alarm for received signal levels below a predetermined level and for signal content indicating an alarm, each of said slave units comprising: a processing unit being configured to be operable to control transmission and reception with said master unit, and to process transmitted and received signals, a port for communicating with computing devices, and a speaker unit for producing an audible alarm, said master unit communicating separately with each of said slave units.

2. The system as recited in claim 1, further comprising a charging system being configured to be operable for at least charging batteries of said slave units, transferring operational settings to said master unit and said slave units, and synchronizing said master unit to each of said slave units.

3. The system as recited in claim 2, in which said charging system further comprises a port being configured for communicating with an external computing device.

4. The system as recited in claim 3, in which said charging system is further operable for transferring programming instructions to said master unit and said slave units.

5. The system as recited in claim 2, in which said charging system is further operable for assigning one of said slave units the operations of said master unit to replace said master unit.

6. The system as recited in claim 1, further comprising a sub-master unit being configured to be operable to at least transmit and receive signals, determine signal levels of received signals, and activate an alarm for received signal levels below a predetermined level, said sub-master unit at least comprising: a processing unit being configured to be operable to control transmission and reception with said master unit and said slave units, and to process transmitted and received signals, a port for communicating with computing devices, and a speaker unit for producing an audible alarm.

7. The system as recited in claim 2, in which deactivation of said alarm on said master unit and a respective slave unit requires close proximity to the said units.

8. The system as recited in claim 2, in which said alarm continues sounding on said master unit and a respective slave unit for a determined period of time.

9. The system as recited in claim 1, in which said transmitted signals between said master unit and said slave units are encrypted.

10. The system as recited in claim 1, in which a volume setting of said audible alarms is maintained at the highest level setting in the system.

11. The system as recited in claim 10, in which a lower volume setting of said audible alarms is only enabled by setting said lower volume setting as said highest level setting in the system.

12. The system as recited in claim 1, in which said slave units are tagged to objects to be tracked.

13. The system as recited in claim 1, in which said master unit is further operable for sending an alarm signal to said slave units to activate the alarms of said slave units.

14. The system as recited in claim 1, in which said master unit maintains a running average of said signal levels of received signals to compare to said predetermined level for activation of said alarm.

15. A system comprising:
first means being configured to be operable for at least transmitting and receiving signals, determining signal levels of received signals, and activating an alarm for received signal levels below a predetermined level; and
at least two second means being configured to be operable for at least transmitting and receiving signals, determining signal levels of received signals, and activating an alarm for received signal levels below a predetermined level and for signal content indicating an alarm.

16. The system as recited in claim 15, further comprising means being configured to be operable for at least charging batteries of said second means, transferring operational settings to said first means and said second means, and synchronizing said first means to each of said second means.

17. The system as recited in claim 15, further comprising third means being configured to be operable for at least transmitting and receiving signals, determining signal levels of received signals, and activating an alarm for received signal levels below a predetermined level.

18. A system comprising:
a master unit being configured to be operable to at least transmit and receive signals, determine signal levels of received signals, and activate an alarm for received signal levels below a predetermined level, said master unit at least comprising: a processing unit being configured to be operable to control transmission and reception on multiple frequencies, and to process transmitted and received signals, a port for communicating with computing devices, and a speaker unit for producing an audible alarm;
at least one slave unit being configured to be operable to at least transmit and receive signals, determine signal levels of received signals, and activate an alarm for received signal levels below a predetermined level and for signal content indicating an alarm, with said slave units comprising: a processing unit being configured to be operable to control transmission and reception with said master unit, and to process transmitted and received signals, a port for communicating with computing devices, and a speaker unit for producing an audible alarm, said master unit communicating separately with each of said slave units; and
a charging system being configured to be operable for at least charging batteries of said slave units, transferring operational settings to said master unit and said slave units, and synchronizing said master unit to each of said slave units.

19. The system as recited in claim 18, further comprising a sub-master unit being configured to be operable to at least transmit and receive signals, determine signal levels of received signals, and activate an alarm for received signal levels below a predetermined level, said sub-master unit at least comprising: a processing unit being configured to be operable to control transmission and reception with said master unit and said slave units, and to process transmitted and received signals, a port for communicating with computing devices, and a speaker unit for producing an audible alarm.

20. The system as recited in claim 19, in which; said charging system further comprises a port being configured for communicating with an external computing device and is further operable for transferring programming instructions to said master unit and said slave units and for assigning one of said slave unit the operations of said master unit to replace said master unit, deactivation of said alarm on said master unit and a respective slave unit requires close proximity the said units, said alarm continues sounding on said master unit and a respective slave unit for a determined period of time, said transmitted signals between said master unit and said slave units are encrypted, a volume setting of said audible alarms is maintained at a highest level setting in the system, a lower volume setting of said audible alarms is only enabled by setting said lower volume setting as said highest level setting in the system, said slave units are tagged to objects to be tracked, said master unit is further operable for sending an alarm signal to said slave units to activate the alarms of said slave units, and said master unit maintains a running average of said signal levels of received signals to compare to said predetermined level for activation of said alarm.
